(19) United States
(12) Patent Application Publication
(10) Pub. No.: US 2016/0158650 A1
(43) Pub. Date: Jun. 9, 2016

(54) System and Method for Providing a Digital Advertising Game

(71) Applicant: Stephanie Yinman Chan, Saratoga, CA (US)

(72) Inventor: Stephanie Yinman Chan, Saratoga, CA (US)

(21) Appl. No.: 14/562,514

(22) Filed: Dec. 5, 2014

(51) Int. Cl. A63F 13/61; A63F 9/18; A63F 13/35

(52) U.S. Cl. CPC A63F 13/61; A63F 13/35; A63F 9/183

(57) ABSTRACT

This invention relates generally to a method of contextual, digital, and interactive advertisement where a consumer or user is incentivized to participate in a game in order to earn prizes. This invention allows the consumer to more thoroughly engage with a brand advertisement, with the effect of supplementing and enhancing the marketing message of the brand advertisement.

### CROSS REFERENCE TO RELATED APPLICATIONS

This application is a continuation in part of U.S. patent application Ser. No. 14/478,280 entitled System and Method for Digital Advertising, filed on Sep. 5, 2014, and U.S. patent application Ser. No. 14/509,205, entitled System and Method for Providing a Multiplayer Text-Based Game via an Interconnected Computer Network, filed on Oct. 8, 2014, the entire disclosures of which are incorporated herein by reference.

### FIELD OF THE INVENTION

The present invention generally relates to a system and method for advertising. Specifically, this invention relates to an online method for contextual, digital, and interactive advertisement where a consumer or user is incentivized to participate in a game in order to earn monetary awards.

### BACKGROUND OF THE INVENTION

Advertisement is a form of communication where the advertiser conveys a message about its product or service to a user and the user receives the message. Advertisements are most effective when a user is fully receptive of an advertisement message. However, with the inundation of advertisements, many users have adapted to ignore advertisements. Even if the user does not ignore an advertisement, the abundance of advertisements (from television, radio, Internet, product placement, billboards) competing for the user's attention thwart any lasting impression. Accordingly, advertising as a means of marketing becomes an ineffectual exercise in garnering attention of a user.

This is also especially true with online advertisement. An Internet user encounters ads while performing a search inquiry, visiting a social networking site, or while browsing news-based websites. Internet advertising is truly ubiquitous.

Current forms of advertisement, including online advertisement, entail passive participation from the user. Advertisements are designed such that the attention of a user is seized through subject-matter, visual or auditory appeal. For example, when a user is on the Internet, there may be a banner advertisement which displays a vehicle. If the user is interested, he may scroll the mouse pointer over the banner and it may enlarge and display a short video marketing the particular vehicle. However the user may or may not view the entire video. Furthermore, this advertisement may be for one of several vehicles that the user may encounter during a single Internet-use session. Accordingly, this display form of advertisement is inefficient for advertisers. With so many advertisements vying for attention from the user and with the ability of the user to skip viewing of an advertisement, the message of an advertisement is not effectively being communicated to the user.

Therefore, there is a need in the art for a method that distinguishes an advertisement and further instills the message of the advertisement by providing an advertisement experience that delivers more interaction with the advertisement. These and other features and advantages of the present invention will be explained and will become obvious to one skilled in the art through the summary of the invention that follows.

### SUMMARY OF THE INVENTION

Accordingly, it is an object of the present invention to provide a system and method for a game that induces a user to focus on actively engage with the brand messaging and advertising. The game is implemented on a computing and/or mobile device. Specifically, the format of the game is for a user to complete different advertising content modules. The modules include watching a supplied video, replicating text displayed in a text box, playing a video game or puzzle, and reading comprehension. After completing the content modules, the user takes a quiz to validate if the advertising content in the advertising content modules is learned by the user. The contents of the video, text, and the quiz relate to the same subject matter.

According to an embodiment of the present invention, an interactive advertisement and game web-based application system includes: an advertisement and game module, which comprises a computer-executable code stored in non-volatile memory, a processors, a communications means, and a display element, where the advertisement and game module, the process and the communications means are operably connected and are configured to transmit and receive data for executing a game, permit a user to register through the web-based application, a social media site or a user's email; queue users in preparation for the game until start time; display a video-based content relevant to a good or service to the users (Event A); display a text-based content box relevant to the good or service to the users, request users to perform two or more tasks, such tasks include replicating the text in the text box through a graphical user interface (Event B) and taking a quiz (Event C) based on the content of the video and text box via user interface, collect and store user participation statistics for each user's participation performance (including game completion time, task completion time, game success, task success, game score and task score), display each user's participation statistics for their performance; and reward users based on successful completion of the game.

The video-based content is an advertisement for a goods or service. The video may be a commercial, or the video may be informative piece about a particular brand. Generally, the text will be informative and provide facts and details about the brand. The quiz asks questions based on the contents of the video and/or the text. In a preferred embodiment, the quiz will ask at least three questions.

According to an embodiment of the present invention, the processor, the memory, and the advertisement and game module are further configured to permit users to replicate text-based content as stated in the text box in a select frame area. In another embodiment, the text-based content may be replicated and transmitted via a text messaging service. Such text messaging service may include short message service (SMS) or multimedia messaging service (MMS).

According to an embodiment of the present invention, the processor, the memory, and the advertisement and game module are further configured to include additional tasks. In addition to taking a quiz, the game may include other at least one of an additional game or puzzle (each game or puzzle individually, Event N) such as Pac-Man.

In an alternative embodiment of the present invention, an interactive advertisement and game web-based application system includes one of a different combination of events.

According to an embodiment of the present invention, the processor, the memory, and the advertisement and game module are further configured to queue users until the commencement of the game. Users may see others who will play the game.

According to an embodiment of the present invention, the processor, the memory and the advertisement and game module are further configured to collect, store, and display users' statistics for completion of each task and the entirety of the game. The users' success or failure at each task is also displayed with details. Users' times may be seen by users and non-users.

According to an embodiment of the present invention, users may earn prizes in a multitude of ways. The users who earn the fastest times may earn rewards. However, users who have completed the game may be eligible for other types of rewards or prizes. In some embodiments, successfully-completed users may earn prizes through a random drawing.

According to an embodiment of the present invention, the display element of the game includes digital real estate for advertisements (ad slots). Advertisements may be displayed upon these ad slots throughout the game. Such advertisements can be image or video based. Such ad slots may be pre-purchased or engaged in real-time bidding (RTB) for display of advertisements.

### BRIEF DESCRIPTION OF THE DRAWINGS

FIG. 1 illustrates a schematic overview of a computing device, in accordance with embodiments of the present invention;

FIG. 2 illustrates a schematic overview of a network, in accordance with embodiments of the present invention;

FIG. 3 illustrates a schematic of a system for an interactive advertisement and game web-based application in accordance with embodiments of the present invention;

FIG. 4 illustrates a schematic flow-chart of an exemplary method in accordance with embodiments of the present invention;

FIG. 5 illustrates a schematic flow-chart of an embodiment of the present invention.

### DETAILED SPECIFICATION

The present invention provides an advertisement and game web-based application system in which brand awareness is raised through an interactive game that incentivizes users to participate by offering rewards. The premise of the game is to inform users about a specific brand through video and text content, ask users to replicate the text content, ask the users questions based on the information provided through the video and/or the quiz, and reward users if the text is replicated accurately and the questions are answered correctly.

The ideology behind the interactive game is based on the rule of three. The rule of three states a grouping of objects/things into threes is an effective means of engaging users. Based on this principle a premise of the interactive game is that users are given three separate tasks to complete and further, as part of one of the tasks, users are asked three key questions. All the tasks focus on a particular goods or service. Repeated exposure to information about the goods or service in an interactive manner will distinguish the product or service from competing brands. Further, answers to questions through a quiz create a lasting impression on the users. The impression increases brand awareness and ultimately, the brand name itself gains notoriety. The ideal outcome is that the brand becomes instantly recognizable without need for additional context.

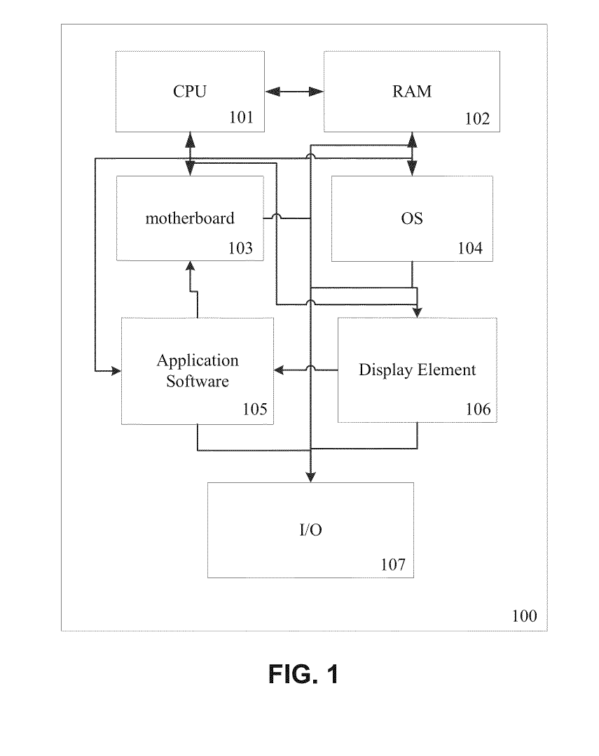

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, display element 106 and one or more input/output devices/means 107. Examples of computing devices usable with embodiments of the present invention include, but are not limited to, personal computers, smart phones, laptops, mobile computing devices and tablet PCs and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet, cellular data networks). In accordance with the previous embodiment, the system may receive data from one or more servers or other computing devices communicatively connected across one or more LANs and/or WANs. One of ordinary skill in the art would appreciate that there are numerous manners in which the system could connected and configured to receive and transmit (where applicable) data and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however a user may be able to compose data offline that will be consumed by the system when the user is later connected to a network.

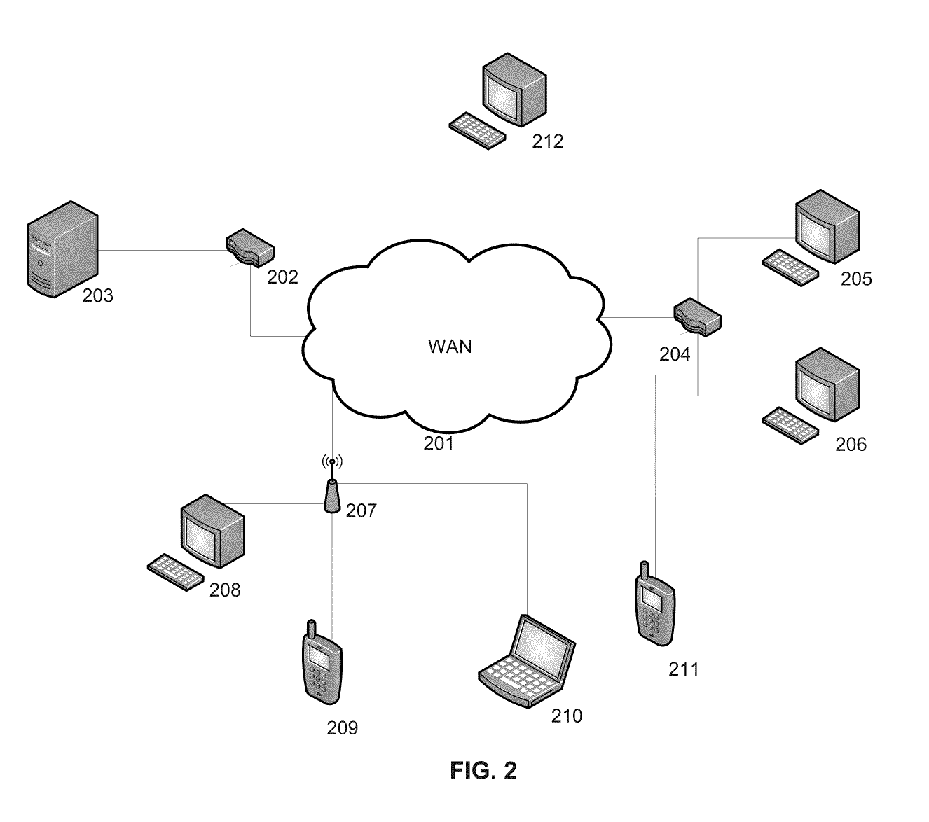

Referring to FIG. 2, a schematic overview of a system in accordance with an embodiment of the present invention is shown. Connection to such networks may be required or desirable for mobile computing device 211 to receive data from any number of sources required for generation of the user interface in accordance with embodiments of the present invention. According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information with the mobile computing device 211 or with other computing devices for use with embodiments of the system, and embodiments of the present invention are contemplated for use with any method for connecting to networks for the purpose of exchanging information. Further, while this application refers to high speed connections, embodiments of the present invention may be utilized with connections of any speed.

Components of the system (e.g., mobile computing device 211) may utilize information and data provided by a connection to data server 203 via Network 201 or other network in numerous ways. For instance, a component may connect to the system: i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a mobile computing device 211 may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

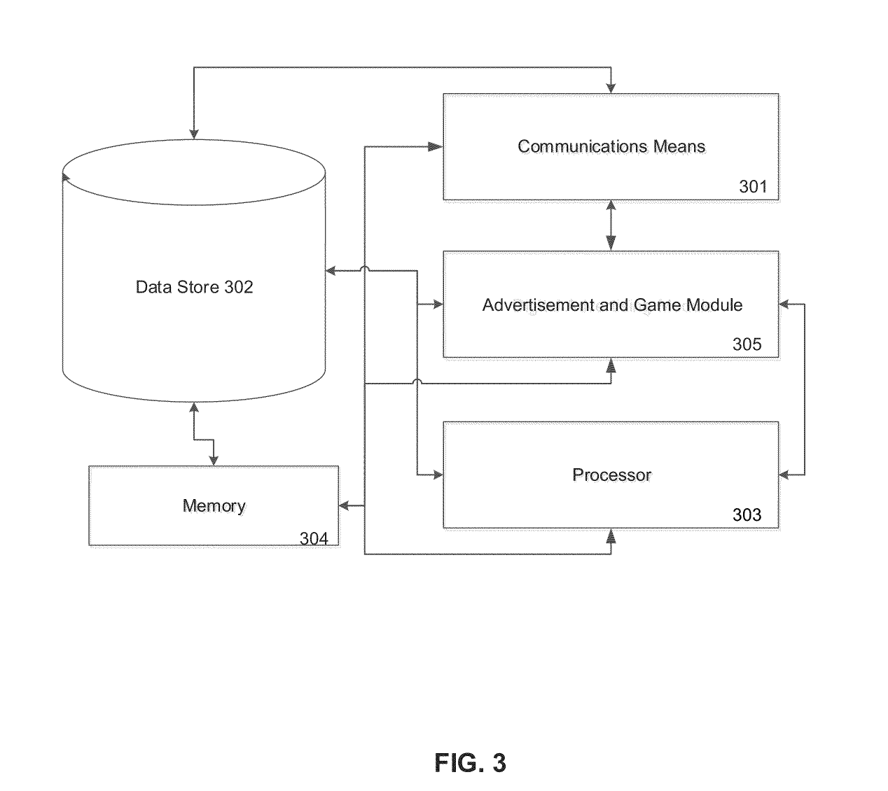

Turning now to FIG. 3, according to an embodiment of the present invention, an interactive advertisement and game web-based application system is comprised of one or more communications means 301, one or more data stores 302, a processor 303, memory 304, and an advertisement and game module 305. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, a communications means 301 may be integrated into the system or communicatively connected to the system and configured to handle the transmission and receipt of data and communications. Communications means 301 include, but are not limited to, Ethernet or other wired communications routers/switches/cards, wireless routers/switches/cards, fiber optic communications devices, cellular communications devices, or any combination thereof. One of ordinary skill in the art would appreciate that there are numerous types of communications means 301 that could be utilized with embodiments of the present invention, and embodiments of the present invention are contemplated for use with any type of communications means.

According to an embodiment of the present invention, the advertisement and game module is configured to work in conjunction with communications means 301, data stores 302, processor 303 and memory 304 in order to provide the methods of the system described herein.

In a preferred embodiment, the user registers and creates a user profile upon initial use. The user can register through the game's main page with a unique user name. Alternatively, the user is able register and sign-in with a social networking account or use another single sign-on method. The user profile details information about the user's history in connection with the present invention. Profile details information may include, but is not limited to, quizzes that a user has completed and prizes and rewards won by the user. A component of the profile may also include saved quizzes (e.g., links to saved quizzes, stored quizzes, stored partially completed quizzes). It is an aspect of certain embodiments of the present invention that the user may opt to take a quiz at a later date.

In a preferred embodiment of the present invention, a user plays the game when a game icon is displayed over an existing digital advertisement. The digital advertisement can be any form of digital advertisement utilized over the Internet. For example, the digital advertisement can be a video advertisement, a banner advertisement, or text-based advertisement (e.g. sponsored content upon a search inquiry). The icon serves to notify the user that the current advertisement is the subject of a game of the current invention.

In a preferred embodiment, the icon appears over advertisements that are specifically targeted to the user based on demographic profile. Demographic profiles include gender, race, ethnicity, profession, education, hobbies, marital status, Internet usage habits, or any combination thereof. One of ordinary skill in the art would appreciate that there are numerous types of demographic profile information that could be utilized with embodiments of the present invention, and embodiments of the present invention are contemplated for use with any type of demographic profile information. Such targeting improves the efficiency of the present invention. By utilizing demographic profiles so that a user is matched with a product of interest, the marketing efforts of the advertiser are made more efficient.

In another embodiment, a user plays the games by visiting a website or opening a mobile/web/software based application on a computing and/or mobile device such as a cell phone or a tablet with wireless capabilities.

In a preferred embodiment of the invention, the user is presented with a video (Event A) that is either preceded by or followed by a text box. The subject matter of the video and text box is the same. By presenting the subject matter is different formats, the user is better able to absorb the advertising content. Following the presentation by video and text, the user is asked to replicate the contents of the text box (Event B). Once this is task is completed, users are then presented with a quiz pertaining to the video and text-box content (Event C).

The quiz portion of the game can be of various formats. In the preferred embodiment, the quiz consists of question-answer format. Other embodiments include selecting a true or false statement among those presented or a multiple choice format. In a preferred embodiment, the quiz consists of three questions or statements. Embodiments that utilize additional or fewer questions are also envisioned.

Users are rewarded upon correctly completing all the tasks and successfully answering all the questions. Game success is defined as an accurate reproduction of the text-based content and correctly answering of all the questions. The reward serves to incentivize users to watch the video, read the text and answers the questions. Watching the video and reading the text informs the user about the product, and answering of the quiz questions serves to consolidate the knowledge learned from the videos and text and enhance brand awareness.

Once a user successfully completes a game, a reward is earned. In the preferred embodiment, the user earns monetary currency. For example, for each perfectly-scored quiz, the user can earn from $0.10-$0.25. Once the user earns a certain threshold amount, for example, $20.00, the monetary award is distributed to the user via a money transfer service, such as PayPal. Payments can be made to the user on a monthly basis.

In an embodiment of the invention, users can earn money for charities. By registering under the name of a preferred charity, the user donates money to a select charity with each earnings.

In embodiments of the invention, users can earn physical prizes in lieu of or in addition to cash prizes.

A fun and pleasant experience with the advertising content will render a positive impression of the advertising content. Accordingly, in an embodiment of the invention, users can compete with one another in battle mode. In battle mode, two or more users compete to correctly complete the game in the fastest time. In one version, the winner of battle mode earns the displayed amount. In another version, the winner of battle mode earns the sum of both users' participation. In another version the winner and user will earn different proportions of the sum total.

In the preferred embodiment of the battle mode, a video is followed by a text-box. The video will have the same or similar advertising content from the same sponsor as the text-based message. This multiple presentation of the same subject matter will better instill the advertising content in the users. There may be three or more rounds of battle mode. In round 1, users are required to watch a video (Event A). In round 2, users are required to replicate the contents of the text-based message by typing in the allotted space (Event B). In round 3, users are required to complete the quiz (Event C). Other embodiments of this invention may include additional rounds (Event A, B, C or N). Accordingly, users are actively engaging with the subject matter. The user with the fastest time will earn rewards.

In another embodiment, users will type the text-based image (Event B) through a text messaging service. Such text messaging service may include short messaging service (SMS) or mobile messaging service (MMS).

In another embodiment of the invention in battle mode, additional rounds may include games and puzzles (each game or puzzle is an Event N). These games can be java-based games. Other embodiments may include games designed for a micro-application platform. The game and/or puzzles will have an objective of raising brand awareness of a goods or service. To illustrate an example, a software application developer of a taxi service may contribute a game to the current invention requiring users to navigate through a taxi through the highways and streets of a city.

In an embodiment of the current invention, games and puzzles can be provided by third party developers. Such third party developers may include independent game or puzzle developers, goods or service providers, or users.

Various embodiments of the current invention are envisioned. In one embodiment, advertisers and sponsors may decide which events they want to incorporate in battle mode. When sponsors are given control of battle mode, they may use any event and any number of events to integrate within a session. As an example, a sponsor may elect Event A and Event B to be one embodiment of battle mode.

In an embodiment of the invention in battle mode, users are required to log into the invention before the commencement of battle mode. The log-in requirement is analogous to requiring runners to approach a starting line before commencement of a race. By logging in, users may be able to see other users participating in battle mode. In an embodiment, users who are not logged on will nevertheless be able to view statistics regarding the users participating in battle mode. These statistics may be in graphical form, and may include the number of users participating, and the number of users who have completed each round of battle mode. Non-participating users can also view a leaderboard displaying participating users and their respective times.

In an embodiment of the invention in battle mode, users who failed to log-in by the appropriate time can still participate. The invention is able to distinguish between users who began at the game at commencement time and those who began afterwards. Any user who participates while the battle mode is in session and successfully completes all the rounds may still earn a reward from a sponsor.

Rewards and prizes can be awarded for a multiple of achievements in battle mode. For example, in addition to an award or prize for the fastest time, prizes and rewards can be distributed to the top 100 fastest times or randomly distributed among successfully completed users.

In embodiments of the invention, the battle mode may have accompanying advertisements. The advertisements may be text-based (e.g. banner) or video-based. These advertisements can be in the form of frame ads, where particular space is reserved for display of advertisements, or pop-ups or pop-unders ads, where ads displayed in a frame open in a new window. One of ordinary skill in the art would understand that any number of advertising display methods can be used, and embodiments of the present invention are contemplated for use with any display method.

Data surrounding users who have played the game can be valuable to advertisers. Advertisers often use demographics, behavioral & psychographic data in order to deliver targeted advertisements to specific/qualifying users. The pairing of user, game & brand yields crucial & actionable information that advertisers can leverage to build out robust audiences profiles, model audiences based on said profiles and execute targeted advertising campaign based on such data. This information can be in the form of surveys according to various demographic parameters such as profession, age, and gender—along with more robust data sets such as brand affinity, browsing behaviors and psychographics. Additional parameters can be the frequency & amount of tests taken, and the distribution of perfect and non-perfect scores. Advertisers can then pay to access user surveys.

Text and video content displayed will be submitted by advertisers. This will allow advertisers to control the message conveyed to users and to synchronize an existing advertising campaign over various types of forums. As an illustrative example, if a car manufacturer wants to convey a message about the fuel efficiency of a new vehicle, the manufacturer can convey this message through billboards, television, digital ads, and the current invention. The utility of the current invention solves for the drawbacks with the other advertising forums, namely the passive interaction with the user. However, if the user is incentivized to pay attention to the advertising, even if the purpose is to successfully play a game, the message of the advertising campaign is better conveyed.

In order for advertisers to provide their own text and video, an advertiser intake form will be provided. The intake form will ask for the company name, the brand, a trademarked slogan (or any other unique identifiers), and product information.

Exemplary Embodiment of Battle Mode

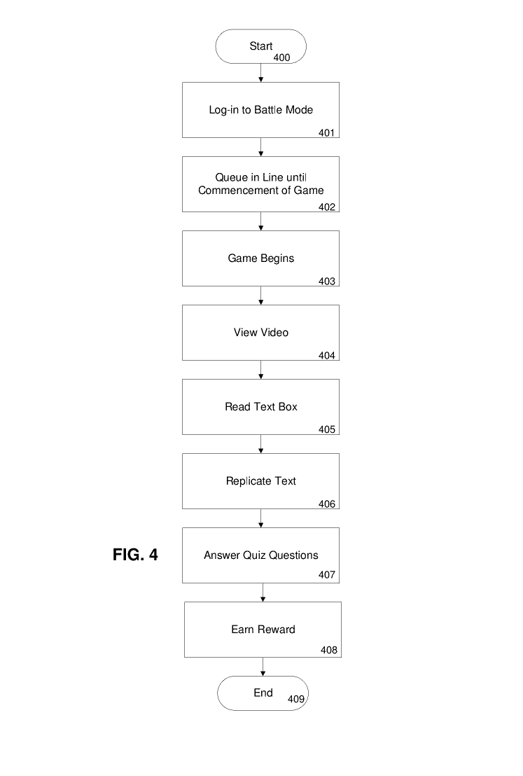

According to an embodiment of the present invention, below is an exemplary method for the interactive advertisement and game web-based application method, as shown in FIG. 4.

At step 400, the method begins with the system being activated. Initial activation of the system begins with the user registering and creating profile. Subsequent activation at step 401 begins whenever the user signs-in to the invention's main page. In the preferred embodiment, the registering device maybe a computer or any other computing device capably equipped with a display element and means to receive user input.

At step 402, users queue to begin playing the game. Because battle mode requires multiple players, a particular time is set so users are given notice of an upcoming game. Once users register, they are held in queue until commencement, at step 403.

At step 403, the game begins. In one embodiment, the first task in the game is to watch a video, step 404. The video will pertain to a brand of a goods or service. Following viewing of the video, step 404, users will be presented with a text box at step 405. The text box will pertain to the same brand of a goods or service as the previously shown video.

Following reading of the text box, users will be enabled to replicate the text of the text box, step 406. In one embodiment, users will be required to type the text in space provided. In another embodiment, users will be required to replicate the text via a text messaging service such as an SMS.

Once users are done replicating the text, users will proceed to the quiz at step 407. The quiz will address subject matter from the video and/or the text. The quiz will consist of three or more questions.

After taking the quiz, the game ends and users may earn rewards. Rewards can be earned for a multitude of reasons. For example, the fastest one hundred users who accurately replicated the text and answered the quiz questions will earn a prize. Other examples include a prize for select users who were able to accurately complete the game, regardless of the time. Rewards can be further provided by sponsors and distributed at their discretion. At step 409, the process terminates. Repeated exposure to the brand through the quiz will create a stronger impression and further raise brand awareness than a single interaction.

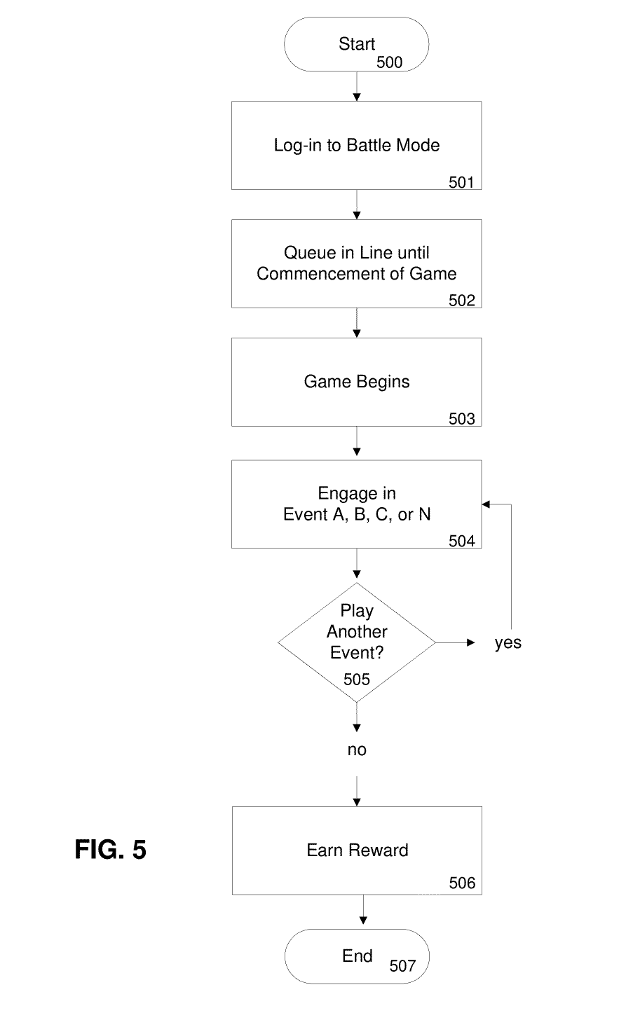

FIG. 5 illustrates another embodiment of the current invention. In this embodiment, an unlimited number of rounds comprising of events is disclosed. Steps 500-503 are identical to steps 400-403 as described above. At step 504, the user is asked to engage in an event. The event can be any of Event A, B, C, or N. After the user completes the event, a decision is made as to whether additional events are desired at step 505. This decision is predetermined before commencement of the game by either agents of the claimed invention or sponsors. If another event is desired, step 504 is repeated with a new event. This loop can be repeated many times. When no additional events are required, the user proceeds to step 506 to earn a reward. A reward can be based on fastest time, accurate completion of the game, or simply participating and completing the game. At step 507, the game terminates.

According to an embodiment of the present invention, below is an illustrate method for the interactive advertisement and game web-based application method, as shown in FIG. 5. Steps 500-503 are identical to steps as described above for steps 400-403. At step 504n, a user may be presented with at least two events in any order. For example, a user may be required to engage in Event A followed by Event N. In other embodiments, the user may be required to begin with Event N, followed by Events C, A, or B. The order and number of events is not a limiting feature of the claimed invention.

Following the appropriate number of events, the user then proceeds to step 505 in order to earn a reward following successful completion of the events. At step 5006, the process terminates.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. An interactive advertisement and game web-based application system comprising:
an advertisement and game module, comprising of computer-executable code stored in non-volatile memory,
a processor,
a display element
a memory, and
a communications means,
wherein the advertisement and game module, the processor, the memory, and the communications means are operably connected and are configured to:
transmit and receive data for executing a game;
permit a user to register through the web-based application, a social media site, or a user's email;
queue one or more users in preparation for the game until start time;
display a video-based content relevant to a good or service to the users;
display a text-based content relevant to the good or service to the users;
request the one or more users to perform two or more tasks,
wherein, the tasks include requiring the users to replicate the text-based content through a graphical user interface, and
request the users to take a question-based quiz on the advertising content of the video- and text-based content displayed via a user interface;
collect and store one or more user participation statistics for each of the users, wherein the statistics include game completion time, task completion time, game success, task success, game score and task score;
display the one or more user participation statistics for each of the user; and
reward the users based on successful completion of the game.

2. The interactive advertisement and game web-based application system of claim 1, wherein the users can replicate the text-based content by typing the text-based content in a select frame area.

3. The interactive advertisement and game web-based application system of claim 1, wherein the users can replicate the text-based content by texting the text-based content through a text messaging service.

4. The interactive advertisement and game web-based application system of claim 1, wherein said advertisement and game module distinguishes between users who were queued upon commencement of the game and users who commenced the game after a start time.

5. The interactive advertisement and game web-based application system of claim 1, wherein said advertisement and game module may request said users to perform additional tasks.

6. The interactive advertisement and game web-based application system of claim 5 wherein tasks are incorporated by a micro-application.

7. The interactive advertisement and game web-based application system of claim 5 wherein said additional tasks include engaging in a java-based game.

8. The interactive advertisement and game web-based application system of claim 1, wherein game success is defined as an accurate reproduction of the text-based content and correctly answering of all the questions.

9. The advertisement and game module of claim 1 further configured to provide a digital advertisement at a frame area.

10. An interactive advertisement and game web-based application method comprising:
transmitting and receive data for executing a game;
permitting a user to register through the web-based application, a social media site, or a user's email;
queuing one or more users in preparation for the game until start time;
displaying a video-based content relevant to a good or service;
displaying a text-based content relevant to the good or service;
requesting the one or more users to perform two or more tasks,
wherein, said tasks include requesting users to replicate the text-based content through a graphical user interface, and
requesting the users to take a question-based quiz on the content of the video- and text-based content displayed via a user interface;
collecting and storing one or more user participation statistics for each of the users, wherein the statistics include game completion time, task completion time, game success, task success, game score and task score;
displaying the one or more user participation statistics for each of the user; and
rewarding users based on successful completion.
